(19) United States
(12) Patent Application Publication
(10) Pub. No.: US 2006/0065511 A1
(43) Pub. Date: Mar. 30, 2006

(54) Multidirectional operation device

(76) Inventors: Masato Yamasaki, Okayama (JP); Jun Sato, Okayama (JP)

Correspondence Address: RATNERPRESTIA, P.O. BOX 980, VALLEY FORGE, PA, 19482, US

(21) Appl. No.: 11/232,137

(22) Filed: Sep. 21, 2005

(30) Foreign Application Priority Data
Sep. 29, 2004 (JP) 2004-283858

(51) Int. Cl. H01H 13/70

(52) U.S. Cl. 200/5 R

(57) ABSTRACT

A multidirectional operation device includes a multidirectional operation switch having an operating shaft extending upward, an operating knob attached on the operating shaft of the multidirectional operation, and an elastic body fixedly bonded to at least one of the multidirectional operation switch and the operating knob, the operating shaft being made airtight. Even when the operating shaft is pressed or bent, the isolation between the inside and outside of the elastic body is maintained, thereby making a multidirectional operation device small in size and excellent in dust and drip proofness.

### BACKGROUND OF THE INVENTION

1. Field of the Invention

The present invention relates to a multidirectional operation device as an input operation unit of mobile communications devices or various miniaturized and multifunctional electronic appliances, and more specifically, relates to a multidirectional operation device with a multidirectional operation switch activated by bending or pressing an operating shaft.

2. Background Art

In recent years, more and more of mobile communications devices such as mobile phones and pagers, and of various miniaturized and multifunctional electronic appliances including audio-video equipment and game machines have been provided with a multidirectional operation device having a multidirectional operation switch activated by a bending or pressing operation.

One such conventional multidirectional operation device will be described as follows with reference to FIGS. 6 and 7.

FIG. 6 is a cross sectional view of the conventional multidirectional operation device. FIG. 7 is an exploded perspective view, seen from the bottom side, of a packing and an operating knob before being assembled together, which are a main part of the conventional multidirectional operation device.

The conventional multidirectional operation device includes wiring board 1 and multidirectional operation switch 2 soldered on the top surface of wiring board 1. Multidirectional operation switch 2 can be functioned as a switch by pressing or bending operating shaft 2A extending upward from the switch main body.

Operating knob 4 has approximately disk-shaped operating part 4A on its top end, and cylindrical part 4C under operating part 4A. Operating part 4A is larger in diameter than cylindrical part 4C formed under it. Cylindrical part 4C is provided, around its center in the height direction, with circular external groove 4B orthogonal to the axial direction of the cylinder. Cylindrical part 4C is further provided, on its bottom, with insert hole 4D to which the upper part of operating shaft 2A is inserted and fixed.

Wiring board 1 mounted with multidirectional operation switch 2 is fixed to frame 3 of an electronic appliance with screws 7. Frame 3 is fixed with screws 7 to the bottom surface of boss 5B of case 5 placed on the operation side of the electronic appliance. As a result, operating knob 4 is disposed in such a manner that cylindrical part 4C is accommodated in hole-for-knob 5A of case 5, and that operating part 4A is projected above case 5.

Flat planar flexible packing 6 has opening 6A approximately in its center. Opening 6A is engaged with circular external groove 4B formed on the outer surface of operating knob 4, and the periphery of packing 6 is held between case 5 and frame 3.

The diameter of opening 6A is smaller than that of cylindrical part 4C and is slightly larger than that of cylindrical part 4C at the point where external groove 4B is formed. To engage operating knob 4 and packing 6 with each other, operating knob 4 is press-fitted into opening 6A from the bottom to deform packing 6, so that opening 6A of packing 6 is inserted into circular external groove 4B as shown in FIG. 6.

At this moment, even when its periphery is held between case 5 and frame 3, packing 6 can be easily deformed around opening 6A because of its flexibility, in response to the bending or pressing operation of operating knob 4.

In the conventional multidirectional operation device thus structured, when operating knob 4 is pressed or bent, operating shaft 2A to which operating knob 4 is fixed is lowered or bent, thereby making multidirectional operation switch 2 generate a switch signal corresponding to the operated direction of operating knob 4. On the other hand, when the operating force to operating knob 4 is removed, the original state shown in FIG. 6 is restored. Packing 6 is engaged, at opening 6A, with external groove 4B of operating knob 4 and is held, at its periphery, between case 5 and frame 3. This structure allows packing 6 to be deformed around opening 6A in response to the operation to operating knob 4. When the operating force is removed, packing 6 returns to the original planar form. Thus, packing 6 has the function of facilitating the retuning of operating shaft 2A to the original upright position.

Packing 6 has another function of preventing dust or water from entering through the slight gap between the base part of operating shaft 2A and the switch main body while operating shaft 2A of multidirectional operation switch 2 is being pressed or bent, thereby protecting multidirectional operation switch 2 against dust and water which would otherwise enter through the gap between hole-for-knob 5A of case 5 and operating knob 4.

One such switch device with a packing is disclosed in Japanese Patent Unexamined Publication No. H05-90757.

In the aforementioned conventional multidirectional operation device, however, opening 6A of flat planar packing 6 is engaged, in a press-fitted manner, with external groove 4B of operating knob 4 fixed to operating shaft 2A of multidirectional operation switch 2. This structure forces packing 6 to be slightly thinner than the groove width. As another problem, after the engagement of opening 6A and external groove 4B, a slight gap remains, between the bottom of external groove 4B and the edge of opening 6A, in the depth direction of external groove 4B (that is, the radial direction of the cylinder). The remaining gap causes packing 6 to be stretched in the direction which further increases the gap, particularly while operating knob 4 is being operated in the direction which deforms the periphery of packing 6. The increased gap may cause water or dust to enter the multidirectional operation switch 2 side, and further inside multidirectional operation switch 2.

On the other hand, as various electronic appliances are being reduced in size, there is a growing demand for smaller multidirectional operation devices.

### SUMMARY OF THE INVENTION

An aspect of the present invention is a multidirectional operation device including a multidirectional operation switch having an operating shaft extending upward, an operating knob attached on the operating shaft of the multidirectional operation, and an elastic body fixedly bonded to at least one of the multidirectional operation switch and the operating knob, and the operating shaft being made airtight.

A multidirectional operation device of the present invention can prevent dust or water from entering a multidirectional operation switch through the base part of the operating shaft while securing the bending and pressing operations of the operating shaft, and the size is also reduced in size.

### BRIEF DESCRIPTION OF THE DRAWINGS

FIG. 1 is a cross sectional view of a multidirectional operation device according to an embodiment of the present invention.

FIG. 2 is an exploded perspective view of the multidirectional operation device according to the embodiment of the present invention.

FIG. 3 is a cross sectional view showing a bent state of the multidirectional operation device according to the embodiment of the present invention.

FIG. 4 is a cross sectional view showing a pressed state of the multidirectional operation device according to the embodiment of the present invention.

FIG. 5 is a cross sectional view of a multidirectional operation device according to another embodiment of the present invention.

FIG. 6 is a cross sectional view of a conventional multidirectional operation device.

FIG. 7 is an exploded perspective view of a main part of the conventional multidirectional operation device.

### DETAILED DESCRIPTION OF THE INVENTION

A multidirectional operation device of the present invention includes a multidirectional operation switch having an operating shaft extending upward, an operating knob attached on the operating shaft, and an elastic body fixedly bonded to at least one of the multidirectional operation switch and the operating knob, the operating shaft being made airtight by a wall formed of at least the multidirectional operation switch, the operating knob and the elastic body.

The elastic body fixedly bonded to one of the multidirectional operation switch and the operating knob surrounds the operating shaft in an airtight manner, and the airtightness is maintained while the operating shaft is repeatedly bent or pressed. Consequently, the base part of the operating shaft is protected against the entry of dust and water. Furthermore, the elastic body, which can be attached so as to surround the operating shaft as mentioned above, can achieve a multidirectional operation device that is small and excellent in dust and drain proofness.

The elastic body may be fixed either on the bottom surface of the operating knob or on the switch main body of the multidirectional operation switch. This fixing of the elastic body makes it easy to handle the elastic body during the manufacturing process, and also prevents the elastic body from being displaced when completed so as to improve workability during assembly operations.

The multidirectional operation device of the present invention may include a multidirectional operation switch operated by pressing or bending an operating shaft extending upward, an operating knob attached on the operating shaft of the multidirectional operation switch, and a nearly planar elastic body fixedly bonded on its inner side to the operating knob and held at its edge by a fixing part of an appliance in which the multidirectional operation device is used. The elastic body may have a circular protrusion which is fixedly engaged with a circular groove formed on the bottom surface of the operating knob, and a planar part which is fixedly bonded to the bottom of the operating knob.

Thus fixedly bonding the elastic body to the operating knob without any gap between them can achieve a multidirectional operation device having excellent dust and drip proofness and improved handleability during assembly operations.

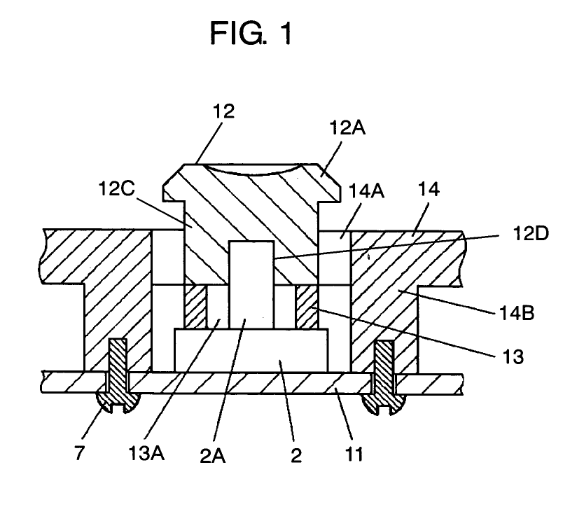

The multidirectional operation device of an embodiment of the present invention will be described as follows with reference to FIGS. 1 to 4.

Note that the components the same as those described in Background Art above are labeled with the same reference marks, and the description is simplified.

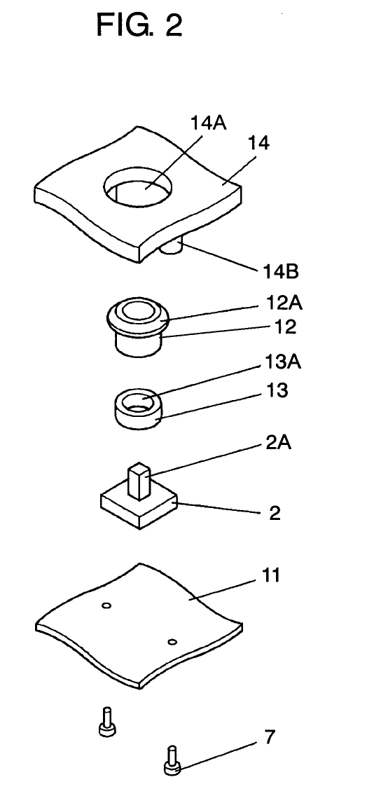

FIG. 1 is a cross sectional view of a multidirectional operation device of an embodiment of the present invention, and FIG. 2 is an exploded perspective view of the multidirectional operation device.

Multidirectional operation switch 2 is provided with operating shaft 2A extending upward from a switch main body, and is activated by bending or pressing operating shaft 2A. On the upper part of operating shaft 2A is attached operating knob 12 made of insulating resin.

Operating knob 12 has approximately disk-shaped operating part 12A on its top end, and approximately cylindrical part 12C which is smaller in diameter than operating part 12A and is formed under it. Cylindrical part 12C is provided on its bottom end with insert hole 12D. Multidirectional operation switch 2 and operating knob 12 are fixed to each other by inserting the upper part of operating shaft 2A into insert hole 12D.

To the bottom surface of cylindrical part 12C of operating knob 12 is fixedly bonded with adhesive the top surface of cylindrical elastic body 13 formed of sponge rubber. Elastic body 13 is in resilient contact with the top surface of the switch main body of multidirectional operation switch 2 and with the bottom surface of operating knob 12. The sponge rubber can be formed by foaming rubber material such as ethylene propylene rubber (EPDM), acrylonitrile butadiene rubber (NBR), urethane or the like.

Operating shaft 2A of multidirectional operation switch 2 is surrounded by elastic body 13 throughout the outer surface. It is preferable that operating shaft 2A be disposed in such a manner as not to come into contact with elastic body 13 surrounding it, while operating shaft 2A is bent or pressed. To achieve this, operating shaft 2A is arranged approximately in the center of cylindrical elastic body 13, and the inner diameter of cylindrical elastic body 13 is much larger than the outer diameter of operating shaft 2A.

Thus, cylindrical elastic body 13 maintains isolation between its inside and outside, with hollow part 13A of elastic body 13 airtight around operating shaft 2A.

Multidirectional operation switch 2 is soldered on the top surface of wiring board 11, which is fixed with screws 7 to boss 14B formed on the bottom surface of case 14. Operating knob 12 is accommodated in hole 14A of case 14 in such a manner as to be capable of being pressed or bent, with operating part 12A formed at the top of operating knob 12 high beyond case 14.

The following is a description of the operation of the multidirectional operation device of the present embodiment thus structured.

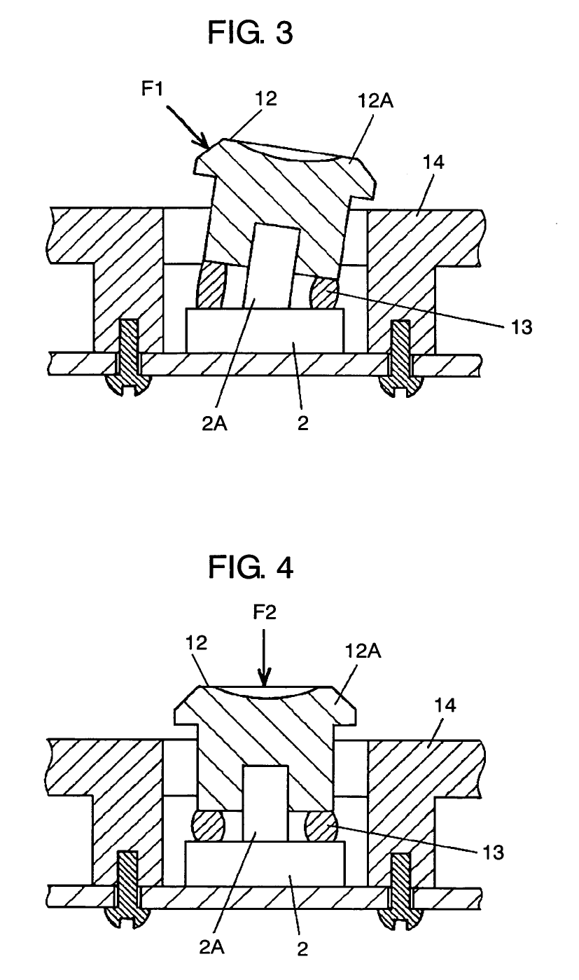

As in the cross sectional view of FIG. 3 showing the bending operation, an upper left end of operating part 12A of operating knob 12 is pressed with a finger or the like with pressing force F1 in an obliquely downward direction indicated by the arrow in the drawing so as to bend operating shaft 2A. Consequently, operating shaft 2A of multidirectional operation switch 2 is bent in the corresponding direction. This allows multidirectional operation switch 2 to provide a switch-on signal of the switch corresponding to the operated direction. At this moment, elastic body 13 is compressed in the direction in which operating shaft 2A is bent, and is slightly stretched in the opposite direction. It is preferable that the inner diameter of elastic body 13 be determined so as not to cause operating shaft 2A to come into contact with the inner surface of elastic body 13 while it is thus bent.

Elastic body 13 is in resilient contact, in a compressed condition, both with multidirectional operation switch 2 and with operating knob 12. Consequently, even when a bending operation causes elastic body 13 to stretch in the direction opposite to the direction in which operating shaft 2A is bent, elastic body 13 never departs, floats or deviates from the switch main body of multidirectional operation switch 2, thereby maintaining the condition of resilient contact. As a result, during the switching operation, the isolation between the inside and outside of cylindrical elastic body 13 is maintained. When pressing force F1 applied to operating knob 12 is removed, operating shaft 2A returns to the original upright position shown in FIG. 1 by the effects of elastic body 13 and the resilience of multidirectional operation switch 2.

When operating shaft 2A is bent in a direction other than the direction shown in FIG. 3, elastic body 13 is compressed in the bent direction and is slightly stretched in the opposite direction in the same manner. Just like in the aforementioned case, elastic body 13 never departs, floats or deviates from the main body of multidirectional operation switch 2, thereby maintaining the condition of resilient contact and the isolation between its inside and outside.

FIG. 4 is a cross sectional view showing a pressing operation. When operating part 12A of operating knob 12 is pressed at the center of its top surface with a finger or the like with pressing force F2 in the direction indicated by the arrow in the drawing, operating shaft 2A as a whole is lowered. Consequently, elastic body 13 as a whole is compressed so as to allow multidirectional operation switch 2 to provide a switch-on signal of the switch corresponding to the operated direction.

When this pressing operation causes the bottom surface of operating knob 12 to compress elastic body 13 as a whole in the axial direction of operating shaft 2A, it is preferable that the inner surface of elastic body 13 never come into contact with operating shaft 2A to maintain the isolation between the inside and outside of cylindrical elastic body 13.

When pressing force F2 is removed, operating shaft 2A returns to the original upright position shown in FIG. 1 by the effects of elastic body 13 and the resilience of multidirectional operation switch 2.

Thus, in the multidirectional operation device of the present embodiment, cylindrical elastic body 13 is in resilient contact with the bottom surface of operating knob 12 on one side and with the switch main body of multidirectional operation switch 2 on the other side, with operating shaft 2A extended inside cylindrical elastic body 13. This arrangement can achieve airtight isolation between the inside and outside of elastic body 13, and the airtight condition is maintained even when operating shaft 2A is bent or pressed. Consequently, the base part of operating shaft 2A is not exposed outside elastic body 13, so that the switch main body of multidirectional operation switch 2 is protected against dust or water which would otherwise enter through the base part of operating shaft 2A.

Furthermore, the structure of the present embodiment can achieve a smaller multidirectional operation device because only cylindrical elastic body 13 is fitted to the bottom surface of operating knob 12 which is attached to operating shaft 2A of multidirectional operation switch 2.

Thus fixedly bonding elastic body 13 to the bottom surface of operating knob 12 allows elastic body 13 to be treated together with operating knob 12 so as to improve workability in the manufacturing process and to prevent displacement of elastic body 13 when completed. This arrangement also reduces the chance of damaging or scratching the inner side of elastic body 13, which would otherwise happen, for example, if elastic body 13 comes into contact with operating shaft 2A.

Since elastic body 13 is fixedly boded to the bottom surface of operating knob 12 by using adhesive, elastic body 13 will not float, deform or cause other problems even after the switching operation is repeated, thus maintaining the airtight condition over a long period of time.

This embodiment describes the case where the top surface of cylindrical elastic body 13 is fixedly bonded to the bottom surface of operating knob 12. However, instead of this, the bottom surface of elastic body 13 may be fixedly bonded to the switch main body of multidirectional operation switch 2 so as to be in resilient contact with the bottom surface of operating knob 12. Alternatively, it is also possible to fixedly bond the top and bottom surfaces of cylindrical elastic body 13 to the bottom surface of operating knob 12 and to the switch main body of multidirectional operation switch 2, respectively, with adhesive.

FIG. 1 shows the case where the top surface of cylindrical elastic body 13 is fixedly bonded to the bottom surface of operating knob 12. Instead of this, a circular groove corresponding to the shape of cylindrical elastic body 13 may be formed on the bottom surface of operating knob 12 so that elastic body 13 can be press-fitted into the groove. As another approach, elastic body 13 may be provided on its top surface with a projected part, and operating knob 12 may be provided on its bottom surface with a groove which corresponds to the projected part so as to press-fit it thereinto, thereby fixedly bonding elastic body 13 to operating knob 12. In this case, it is possible to apply adhesive to the press-fitted part so as to improve the adhesion.

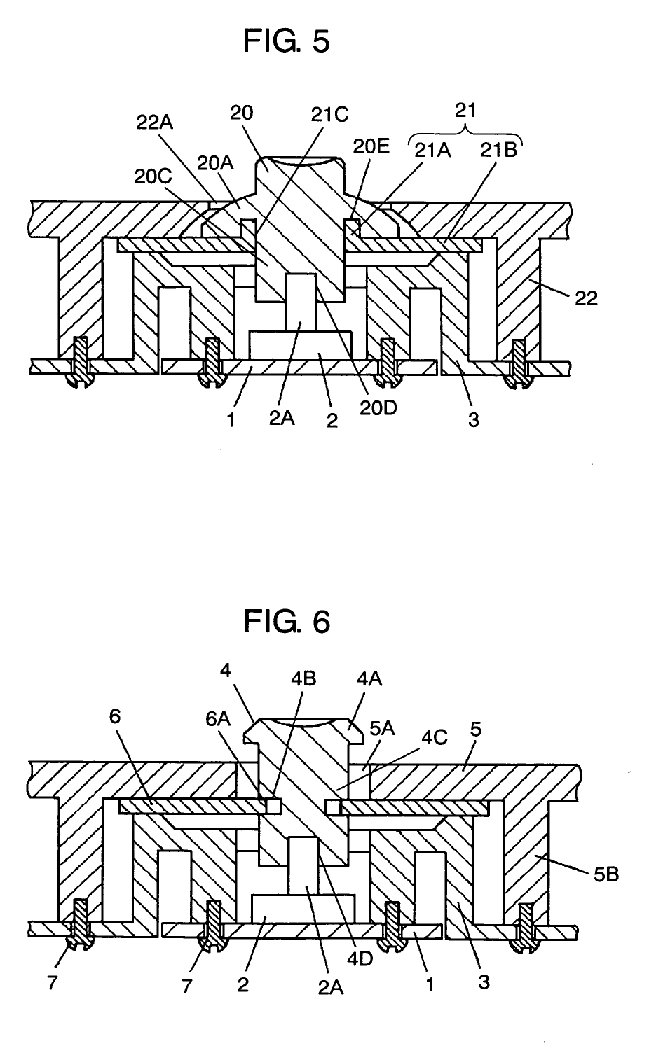

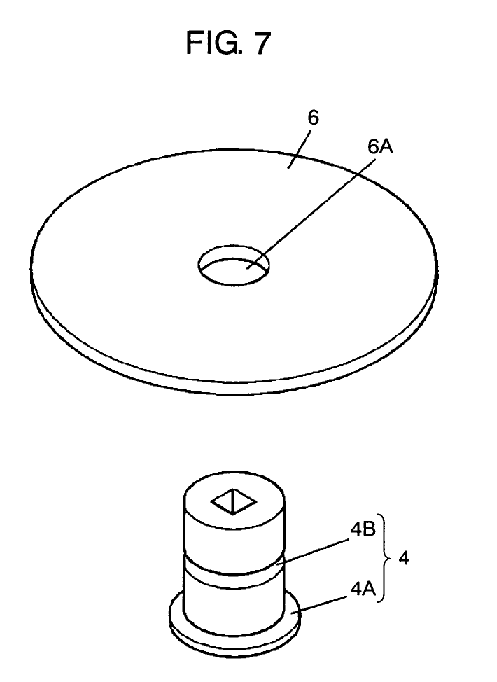

Another embodiment of the present invention is shown in FIG. 5. The multidirectional operation device shown in FIG. 5 includes multidirectional operation switch 2 fixed on wiring board 1 by soldering or the like, operating knob 20 attached on operating shaft 2A of multidirectional operation switch 2, planar elastic body 21 fixedly bonded to operating knob 20, and case 22 attached to the frame 3 of electronic appliance. The upper part of operating knob 20 is projected beyond the opening 22A of case 22. The frame 3 shown in FIG. 5 is an example of a fixing part of the appliance.

Operating knob 20 is provided with cylindrical part 20C and disk-shaped part 20A with a large diameter which is formed on cylindrical part 20C. Cylindrical part 20C is provided, on its bottom, with insert hole 20D into which operating shaft 2A can be inserted. Disk-shaped part 20A is provided, on its bottom surface, with circular groove 20E which has a predetermined width from the outer circumference of cylindrical part 20C in the outward direction and also has a predetermined depth. On the other hand, planar elastic body 21 is provided, in its center, with opening 21C having an inner diameter approximately the same size as the outer diameter of cylindrical part 20C. Planar elastic body 21 is further provided with circular protrusion 21A adjacent to opening 21C, and thin planar part 21B extending from protrusion 21A horizontally in the direction of the outer circumference. Circular protrusion 21A has approximately the same width as circular groove 20E.

Fixedly press-fitting circular protrusion 21A of elastic body 21 into circular groove 20E of operating knob 20, and fixedly bonding planar part 21B to the bottom surface of operating knob 20 can make the multidirectional operation device excellent in dust and drip proofness.

For example, as shown in FIG. 5, the periphery of planar part 21B of elastic body 21 can be held between frame 3 and case 22 so as to isolate the space formed of elastic body 21, frame 3, wiring board 1 and operating knob 20 from outside. In other words, this structure can make the surrounding area of operating shaft 2A airtight.

Elastic body 21 can be a sheet made of rubber material such as EPDM, NBR or urethane.

Thus press-fitting protrusion 21A of elastic body 21 into circular groove 20E of operating knob 20, and fixedly bonding planar part 21B to the bottom surface of disk-shaped part 20A makes it possible to tightly fix elastic body 21 to operating knob 20. As a result, the multidirectional operation device has excellent dust and drip proofness and improved handleability during assembly operations.

In FIG. 5, the adhesion between operating knob 20 and elastic body 21 is secured by press-fitting protrusion 21A into circular groove 20E. Alternatively, it is possible to tightly bond elastic body 21 not having protrusion 21A to operating knob 20 not having circular groove 20E by using adhesive.

The multidirectional operation device of the present invention has the feature of preventing dust or water from entering the switch main body of the multidirectional operation switch through the base part of the operating shaft, while securing the bending and pressing operations of the operating shaft, and also has the feature of small size. Therefore, the multidirectional operation device is useful as the input operation unit of mobile communications devices such as mobile phones and pagers or various small and multifunctional electronic appliances.

What is claimed is:

1. A multidirectional operation device comprising:
a multidirectional operation switch having an operating shaft which extends upward and which can be pressed or bent;
an operating knob attached on the operating shaft; and
an elastic body fixedly bonded to at least one of the multidirectional operation switch and the operating knob, wherein
the operating shaft is made airtight by a wall formed of at least the multidirectional operation switch, the operating knob and the elastic body.

2. The multidirectional operation device of claim 1, wherein
the elastic body is cylindrical;
at least one of ends of the elastic body is fixedly bonded to one of the multidirectional operation switch and the operating knob; and
the operating shaft is made airtight by a wall formed of the multidirectional operation switch, the operating knob and the elastic body.

3. The multidirectional operation device of claim 2, wherein
the elastic body is held in a compressed condition between the multidirectional operation switch and the operating knob.

4. The multidirectional operation device of claim 1, wherein the elastic body is a molded product of sponge rubber.

5. The multidirectional operation device of claim 1 further comprising:
a case attached to a frame of an electronic appliance so as to cover the operating knob, wherein
the operating knob is projected from an opening formed in the case;
the elastic body is a planar elastic body which is provided, in a center thereof, with an opening having a diameter nearly same as an outer diameter of the operating knob;
the elastic body is fixedly bonded to the operating knob on an inner side thereof, and is fixedly bonded between the case and the frame on an outer side thereof; and
the operating shaft is made airtight by a wall formed of the multidirectional operation switch, the operating knob, the elastic body, the frame and the case.

6. The multidirectional operation device of claim 5, wherein
the operating knob includes a cylindrical part and a disk-shaped part formed on the cylindrical part;
the disk-shaped part is provided, on a bottom surface thereof, with a circular groove;
the elastic body is provided, in a region facing the circular groove, with a circular protrusion having approximately same width as the circular groove; and
the circular protrusion is fitted in the circular groove to fixedly bond the elastic body to the operating knob.

7. A multidirectional operation device comprising:
a multidirectional operation switch operated by one of pressing and bending an operating shaft extending upward;
an operating knob attached on the operating shaft; and
a cylindrical elastic body fixedly bonded to the operating knob, wherein
the elastic body is held in a compressed condition between the multidirectional operation switch and the operating knob; and
the elastic body surrounds the operating shaft with a predetermined gap therebetween.

8. A multidirectional operation device comprising:
a multidirectional operation switch operated by one of pressing and bending an operating shaft extending upward;
an operating knob attached on the operating shaft of the multidirectional operation switch comprising:
a cylindrical part; and
a disk-shaped part formed on the cylindrical part, the disk-shaped part having a larger diameter than the cylindrical part and being provided, on a bottom surface thereof, with a circular groove; and
a planar elastic body provided, in a center thereof, with an opening having a diameter approximately same as an outer diameter of the cylindrical part of the operating knob, wherein
the elastic body is provided, in a region facing the circular groove, with a circular protrusion having approximately same width as the circular groove; and
the elastic body is fixedly bonded, on an inner side thereof, to the operating knob by fitting the circular protrusion in the circular groove, and is held, at an edge thereof, by a fixing part of an appliance in which the multidirectional operation device is used.
